(19) United States
(12) Patent Application Publication
(10) Pub. No.: US 2026/0247284 A1
(43) Pub. Date: Aug. 20, 2026

(54) POWER MANAGEMENT FOR AIoT-ASSISTED WIRELESS TRANSMIT/RECEIVE UNITS (WTRUs)

(71) Applicant: InterDigital Patent Holdings, Inc., Wilmington, DE (US)

(72) Inventors: Alec Brusilovsky, Downington, PA (US); Samir Ferdi, Kirkland (CA); Kevin Wanuga, Souderton, PA (US); Guanzhou Wang, Brossard (CA); Anuj Sethi, Ottawa (CA); Taimoor Abbas, Sainte-Julie (CA); Zhibi Wang, Woodridge, IL (US); Michel Roy, Candiac (CA); Xavier De Foy, Kirkland (CA); Magurawalage Chathura Madhusanka Sarathchandra, London (GB); Michael Starsinic, Newtown, PA (US); Mohamad Kenan Al-Hares, Canterbury (GB); Rocco Di Girolamo, Laval (CA); Ulises Olvera-Hernandez, Saint-Lazare (CA)

(73) Assignee: InterDigital Patent Holdings, Inc., Wilmington, DE (US)

(21) Appl. No.: 19/054,320

(22) Filed: Feb. 14, 2025

(51) Int. Cl. H04W 52/02; H04L 5/00

(52) U.S. Cl. CPC H04W 52/0229; H04L 5/0053; H04W 52/0274

(57) ABSTRACT

A method implemented by a wireless transmit/receive unit (WTRU) is disclosed. The method may comprise determining to enter a powered down state and determining a temporary identifier. The method may also comprise sending the temporary identifier to an ambient internet of things (AIoT) device and sending a request to a network to subscribe to a power on or wake-up procedure. The request may include at least the temporary identifier. Further, the method may comprise sending a notification to the AIoT device indicating the WTRU is entering the powered down state and entering the powered down state. Additionally, the method may comprise receiving a wake-up message from the AIoT device and exiting the powered down state in response to receiving the wake-up message from the AIoT device.

### BACKGROUND

Discontinuous Reception (DRX) in 5G New Radio (NR) is a power-saving mechanism designed to extend the battery life of user equipment (UE), such as wireless transmit/receive units (WTRUs), by allowing them to periodically switch their reception state between active and idle modes. In Connected Mode DRX (CDRX), the network maintains context for the WTRU including device ID, control channel configuration, and security parameters. The WTRU monitors a dedicated control channel for messages on a DRX cycle configured by the network. In Idle mode DRX, the context of the WTRU is released, and the WTRU is only capable of monitoring common control channels for, for example, paging messages and updates to system information.

Both DRX modes require the WTRU to periodically monitor control channels, although at different periods and for different types of information. Maintaining context for the WTRU in CDRX enables the WTRU to monitor for more message/signal types from the network, but at the cost of resources reserved by the network for the WTRU (e.g. device IDs, control channel search spaces, etc.). Devices in idle mode can maintain connectivity with the network at lower resource cost, but are only capable of receiving limited forms of broadcast information from the network, and suffer from increased latency as the WTRU must first re-establish connection with the network when a paging message is received.

Current power-saving approaches for a WTRU typically require periodic monitoring of channels which still consume energy (even if at reduced levels) and require the radio access network (RAN) to follow the WTRU sleep/wake schedule, which may increase complexity. Further, in the IDLE mode DRX, the network may be subject to signaling storms as multiple WTRUs may respond to a paging message and attempt to re-initialize connection to determine if they are being paged. As a result, current power-savings approaches for a WTRU offer only limited efficacy with added complexity and do not protect against wake-up signaling storms.

### SUMMARY

Various embodiments are disclosed for performing power management for AIoT-assisted WTRUs. The embodiments may increase the effectiveness of power-savings of WTRUs during dormancy periods, enable networks to increase their power-saving efficiency by scheduling the dormancy periods of the WTRUs, reduce the complexity of the power saving operations implemented by the network, and create conditions to assist networks in controlling signaling storms.

In one aspect, a method implemented by a wireless transmit/receive unit (WTRU) is disclosed. The method may comprise determining to enter a powered down state and determining a temporary identifier. The method may also comprise sending the temporary identifier to an ambient internet of things (AIoT) device and sending a request to a network to subscribe to a power on or wake-up procedure. The request may include at least the temporary identifier. Further, the method may comprise sending a notification to the AIoT device indicating the WTRU is entering the powered down state and entering the powered down state. Additionally, the method may comprise receiving a wake-up message from the AIoT device and exiting the powered down state in response to receiving the wake-up message from the AIoT device.

In another aspect, a first wireless transmit/receive unit (WTRU) is disclosed. The WTRU may comprise a transceiver and a processor. The processor may be configured to determine whether to place the WTRU in a powered down state and to determine a temporary identifier. The processor may also be configured to send the temporary identifier to an ambient internet of things (AIoT) device and to send a request to a network to subscribe to a power on or wake-up procedure. The request may include at least the temporary identifier. Further, the processor may be configured to send a notification to the AIoT device indicating the WTRU is entering the powered down state and to cause the WTRU to enter the powered down state. Additionally, the processor may be configured to receive a wake-up message from the AIoT device and to exit the powered down state in response to receiving the wake-up message from the AIoT device.

In a further aspect, a method implemented by a network is disclosed. The method may comprise determining to place a wireless transmit/receive unit (WTRU) in a powered down state and receiving a request from the WTRU to subscribe to a power on or wake-up procedure. The request may include at least a temporary identifier. The method may also comprise sending an acknowledgment to the WTRU indicating the WTRU is subscribed and determining to initiate the power on or wake-up procedure. Further, the method may comprise retrieve the temporary identifier associated with the WTRU, and send a message to an ambient internet of things (AIoT) or a radio access network (RAN) indicating the WTRU is to exit the powered down state.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an exemplary embodiment;

FIG. 1C is a system diagram illustrating an example radio access network (RAN) and an example core network (CN) that may be used within the communications system illustrated in FIG. 1A according to an exemplary embodiment;

FIG. 1D is a system diagram illustrating a further example RAN and a further example CN that may be used within the communications system illustrated in FIG. 1A according to an exemplary embodiment;

FIG. 2 is a simplified message flow diagram of a power-saving procedure for an AIoT-assisted WTRU, according to an exemplary embodiment.

FIG. 3 is a simplified message flow diagram of a power-saving procedure for an AIoT-assisted WTRU, according to another exemplary embodiment;

FIG. 4 is a state transition diagram for an AIoT-assisted WTRU and a network during a power-saving procedure;

FIG. 5 is a message flow diagram of a power-saving procedure for an AIoT-assisted WTRU according to an embodiment; and

FIG. 6 illustrates a flow diagram of a method of power savings for an AIoT-assisted WTRU, according to an exemplary embodiment.

### DETAILED DESCRIPTION

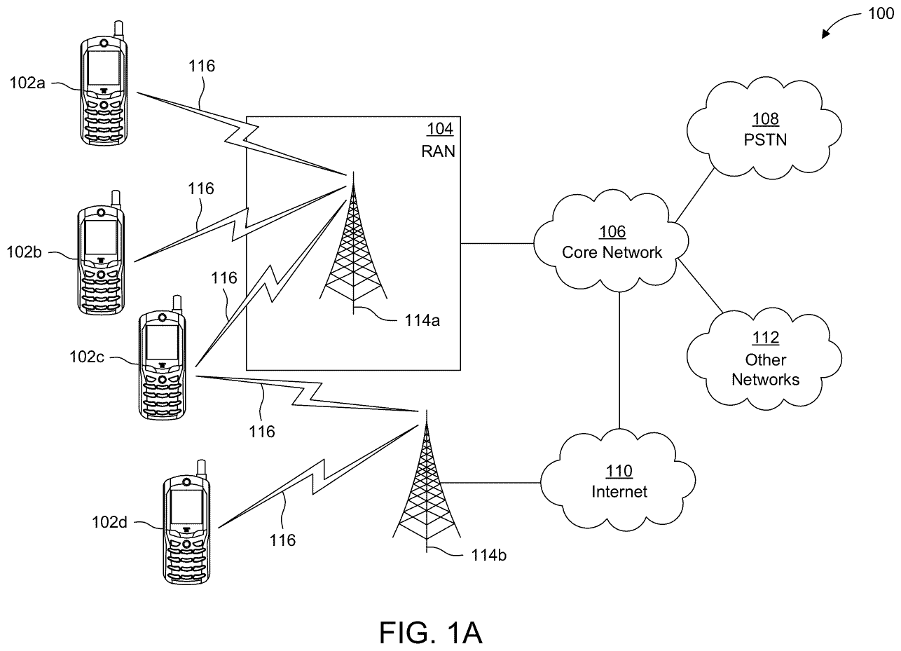

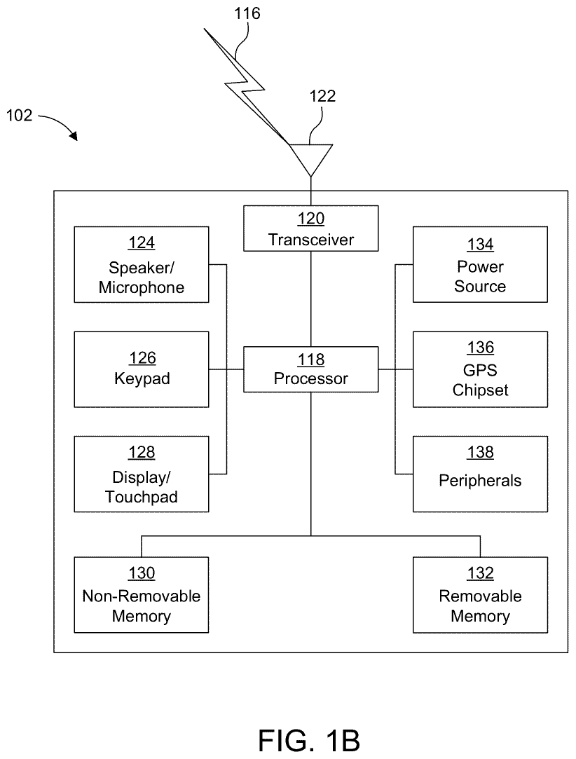

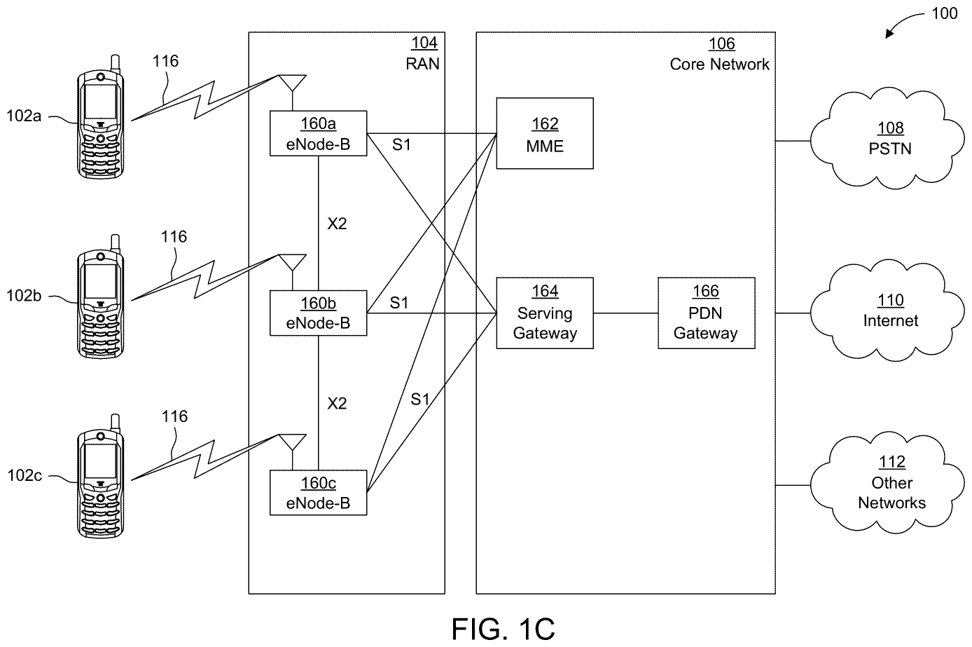

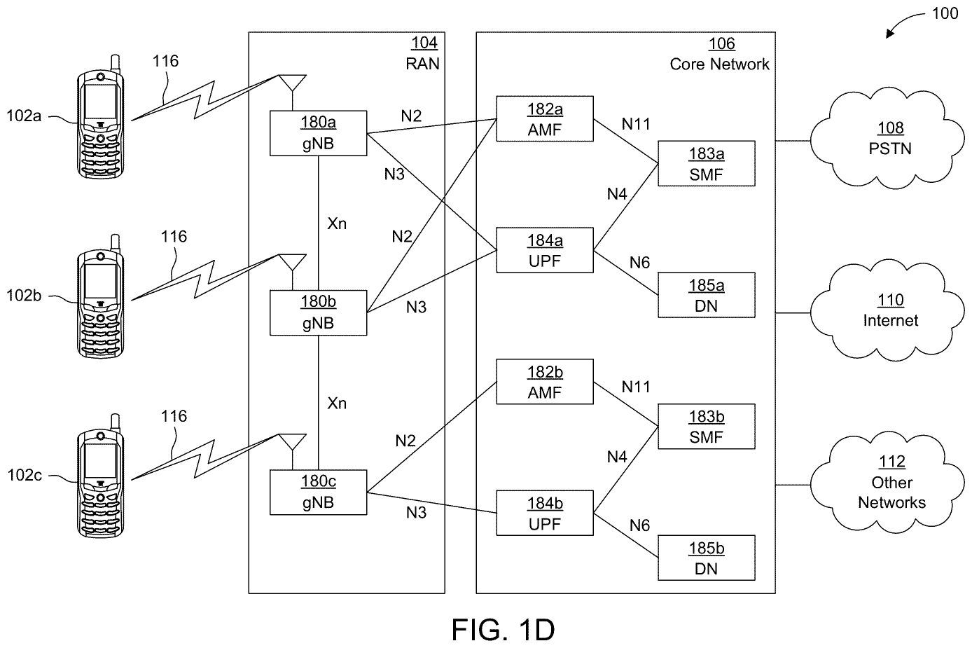

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remain idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on the unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Internet of Things (IoT) devices are physical devices that may be embedded with sensors, software, and other technologies depending on the use case. The devices may connect and exchange data with other devices and systems over a network. These devices may range from everyday objects such as household appliances, wearables, and industrial machinery to more specialized equipment like environmental sensors and smart city infrastructure. These devices may collect, transmit, and/or receive data, allowing them to monitor, control, and/or automate various aspects of our environment to enhance efficiency, convenience, and productivity.

Ambient power-enabled IoT (AIoT) devices are a kind of IoT device that can harvest energy from the environment, such as wireless radio waves, motion, vibration, piezoelectricity, solar and wind power, etc. They may be battery-less or have limited energy storage (e.g., using a capacitor). AIoT devices may have many use cases and may play an important role in smart logistics and smart warehousing such as automated inventory. For example, AIoT devices may be used in industrial wireless sensor networks where the environment is harsh (e.g., extremely high or low temperature) and may be required to be battery-less, maintenance-free, and long service life. The low-cost, small-form, battery-lessness, and durability make AIoTs suitable to be attached to huge amounts of goods and facilitate more efficient goods identifying, sorting, tracking, and inventory. When an AIoT device, attached to inventory such as some goods or an asset, receives an inventory request from a base station or a reader, it may echo with its identifier and/or other information (e.g., location), which may be sent by a wireless network to a service provider for automated inventory management. A network or a service provider may send a “command” to the AIoT device, for example, to activate or deactivate the device, or to modify some information in the device.

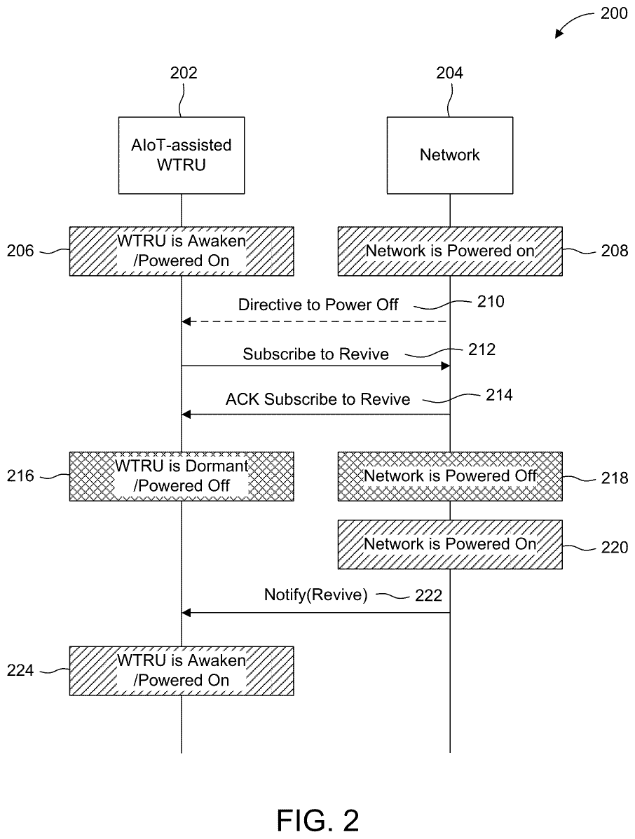

Referring to FIG. 2, a simplified message flow diagram 200 of a power-saving procedure for an AIoT-assisted WTRU 202 is shown, according to an exemplary embodiment. The power-saving procedure may be performed between the AIoT-assisted WTRU 202 and a network 204. The network 204 may be configured to wake-up or revive the AIoT-assisted WTRU 202 from a deep power-saving state. In some implementations, the AIoT-assisted WTRU 202 may comprise an AIoT device and a WTRU (not shown). The WTRU may be in communication with the AIoT device via an interface. The interface may be a wireless or wireline link or connection.

During the power-saving procedure, the AIoT-assisted WTRU 202 may be awakened or powered-on at block 206. At block 208, the network 204 may be powered-on or activated. At 210, the network 204 may send a message or a directive to the AIoT-assisted WTRU 202 directing the AIoT-assisted WTRU 202 to power off/down or retire. In some implementations, the AIoT-assisted WTRU 202 may decide to power off/down or retire itself and may send the network 204 a notification or message that the AIoT-assisted WTRU 202 may be powering down/off or entering into a dormant or sleep state.

At 212, the AIoT-assisted WTRU 202 may send a message to the network 204 requesting to subscribe to a revive event or procedure (e.g., a power on/up service) provided by the network 204. For example, the AIoT-assisted WTRU 202 may send a request to the network 204 to subscribe to a revive or wake-up event for powering on/up the AIoT-assisted WTRU 202. The revive event may involve the network 204 sending a notification or message to the AIoT-assisted WTRU 202 to awaken or revive the AIoT-assisted WTRU 202 from a sleep or dormant state. At 214, the network 204 may send an acknowledgment to the AIoT-assisted WTRU that the AIoT-assisted WTRU 202 has subscribed to a revive event to awaken or revive the AIoT-assisted WTRU 202 from a sleep or dormant state. After the AIoT-assisted WTRU 202 is subscribed to the revive event, the AIoT-assisted WTRU 202 may power-off or enter a sleep or dormant state at block 216. The network 204 may also be powered off or deactivated at block 218. In some implementations, while the AIoT-assisted WTRU 202 is powered off, the network 204 may remain powered on and may not enter a power-savings or dormant mode.

When the network 204 has been powered off, the network 204 may be reactivated or powered on at block 220. After waking up from its powered off or dormant mode, the network 204 may decide to wake-up or revive the AIoT-assisted WTRU 202 and may send a notification or message at 222 to the AIoT-assisted WTRU 202. In some implementations, the message may be sent using a radio access network (RAN). After the message is received by the AIoT-assisted WTRU 202, the AIoT-assisted WTRU 202 may be awakened or revived (e.g., powered on) at block 224. In some implementations, when the AIoT-assisted WTRU 202 includes an AIoT device and a WTRU, the AIoT device may receive the message and may awaken or power on the WTRU. For example, the AIoT device may send a notification or message to the WTRU to awaken or revive (e.g., power on) the WTRU.

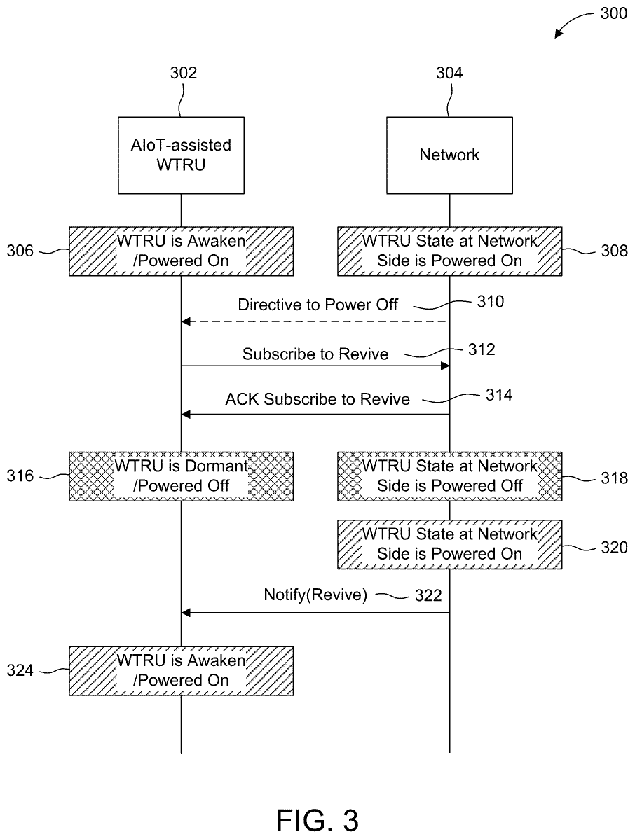

Referring to FIG. 3, a simplified message flow diagram 300 of a power-saving procedure for an AIoT-assisted WTRU 302 is shown, in accordance with an exemplary embodiment. The power-saving procedure may be performed between the AIoT-assisted WTRU 302 and a network 304. The network 304 may include a WTRU state and may be configured to awaken or revive the AIoT-assisted WTRU 302 from a deep power-saving state. In some implementations, the AIoT-assisted WTRU 302 may comprise an AIoT device and a WTRU (not shown). The WTRU and AIoT device may communicate via an interface. For example, the interface may be a wireless or wireline link or connection.

During the power-saving procedure, the AIoT-assisted WTRU 302 may be awakened or powered-on at block 306. At block 308, the WTRU state of the network 304 may be in an active or powered-on mode. At 310, the network 304 may send a message or directive to the AIoT-assisted WTRU 302 directing the AIoT-assisted WTRU 302 to power off/down or retire. In some implementations, the AIoT-assisted WTRU 302 may decide to power off/down or retire itself and may send the network 304 a notification or message that the AIoT-assisted WTRU 302 desires to power down/off.

At 312, the AIoT-assisted WTRU 302 may send a message to the network 304 to subscribe to a revive event or procedure (e.g., a power-on procedure) in the network 304. For example, the AIoT-assisted WTRU 302 may request to subscribe to a revive event or power-on service provided by the network 304. The revive event may involve the network 304 sending a notification to the AIoT-assisted WTRU 302 to awaken or revive the AIoT-assisted WTRU 302 from a sleep or dormant state or mode. At 314, the network 304 may send a message to the AIoT-assisted WTRU 302 acknowledging that the AIoT-assisted WTRU 302 has subscribed to the revive event or power-on procedure provided by the network 304. After the AIoT-assisted WTRU 302 is subscribed to the revive event, the AIoT-assisted WTRU 302 may power-off and/or enter a sleep or dormant state at block 316. The WTRU state at the network 304 may also enter into a powered-off mode at block 318. In some implementations, while the AIoT-assisted WTRU 302 is powered off, the WTRU state of the network 304 may remain in an active or powered-on state and may not enter into a power-savings or dormant mode.

When the WTRU state of the network 304 is in a powered-off mode, the WTRU state of the network 304 may be awakened or powered on at 320. After waking up from the power off or dormancy mode, the network 304 may decide to awaken or revive the AIoT-assisted WTRU 302 and may send a revive notification or wake-up message at 322 to the AIoT-assisted WTRU 302. When the message is received by the AIoT-assisted WTRU 302, the AIoT-assisted WTRU 302 may be awakened or revived (e.g., powered-on). In some implementations, the message may be sent using the RAN. When the AIoT-assisted WTRU 302 includes an AIoT device and a WTRU, the AIoT device may receive the revive notification or wake-up message and may send a message to wake-up or power on the WTRU. For example, the AIoT device may send a notification or message to the WTRU to awaken or revive (e.g., power on) the WTRU. When the message is received by the WTRU, the WTRU may be revived (e.g., powered on) or awakened at block 324. The AIoT device may use an interface to send the message to the WTRU. For example, the AIoT device may send a notification to the WTRU via the interface to awaken or revive (e.g., power on) the WTRU. The interface may be a wireless or wireline link or connection.

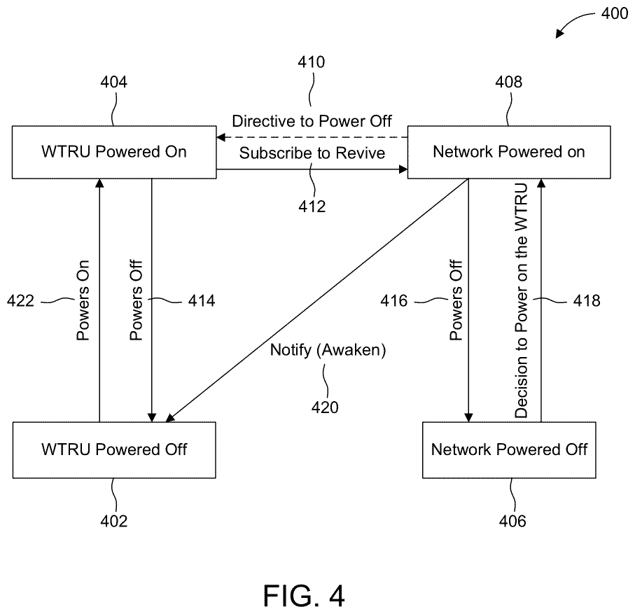

FIG. 4 illustrates a state transition diagram 400 for an AIoT-assisted WTRU and a network during a power-saving procedure, according to an exemplary embodiment. The AIoT-assisted WTRU may transition between two states and the network may transition between two states. For example, the AIoT-assisted WTRU may have a powered-off or dormant state at block 402 and may have a powered-on state at block 404. The network may have a powered off or dormant state at block 406 and may have an active or powered-on state at block 408.

During the power saving procedure, the AIoT-assisted WTRU and the network may each transition between a powered-on state and a powered-off state based on the messages sent between the AIoT-assisted WTRU and the network For example, the network may direct the AIoT-assisted WTRU to initiate a power-saving procedure. As shown in FIG. 4, the AIoT-assisted WTRU may initially have a powered-on or active state at block 404 and the network may initially have a powered-on or active state at block 408. At 410, the network may send the AIoT-assisted WTRU a message or directive directing the AIoT-assisted WTRU to power off/down and/or enter into a dormant state. In some implementations, the AIoT-assisted WTRU may desire to power off/down and may notify the network about its desire to power off/down. At 412, the AIoT-assisted WTRU may send a NAS message to the network to subscribe to a revive event or a power-on service. For example, the AIoT-assisted WTRU may subscribe to a power management service at the network for awakening and/or reviving the AIoT-assisted WTRU. After subscribing to the revive event or power-on service at 414, the AIoT-assisted WTRU may transition from a powered-on state at block 404 to a powered-off state at block 402.

At 416, the network may transition from a powered-on state at block 408 to a powered-off state at block 406. In some implementations, while the AIoT-assisted WTRU 202 is powered off, the network 204 may remain powered on and may not enter a power-savings or dormant mode. At 418, the network may decide to wake-up and to power on the AIoT-assisted WTRU, transitioning from a powered off state at block 406 to a powered-on state at block 408. At 420, the network may initiate an AIoT command procedure and send a notification or a revive (e.g., awaked) command to the AIoT-assisted WTRU, causing the AIoT-assisted WTRU to transition from the powered-off state at block 402 to the powered-on state at block 404. For example, at 422, the AIoT-assisted WTRU may be awakened or revived from a powered-off state and may transition to a powered-on state at 404 based on receiving a wake-up or revive command from the network.

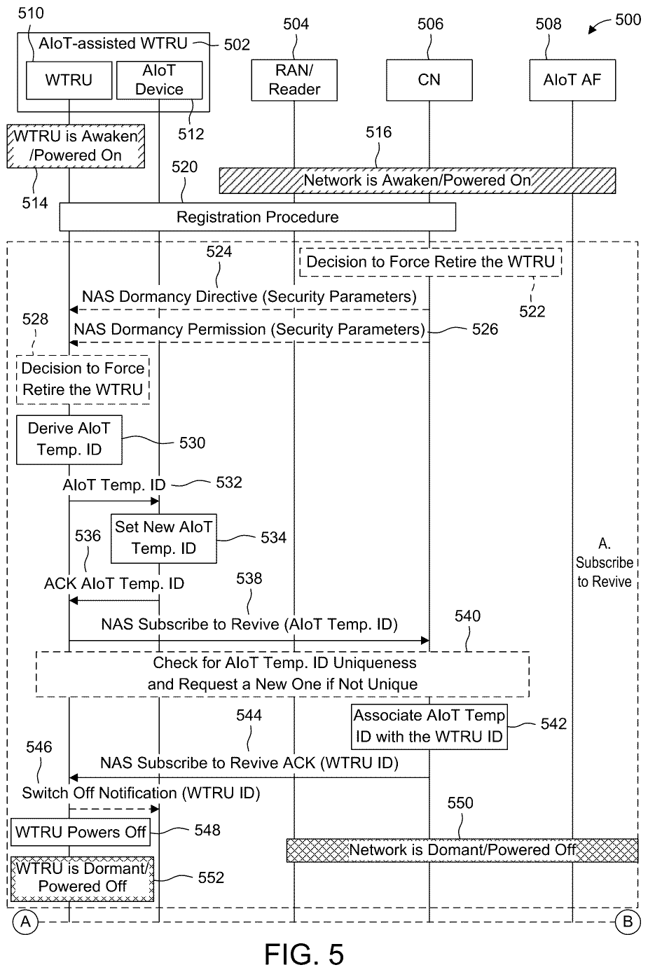

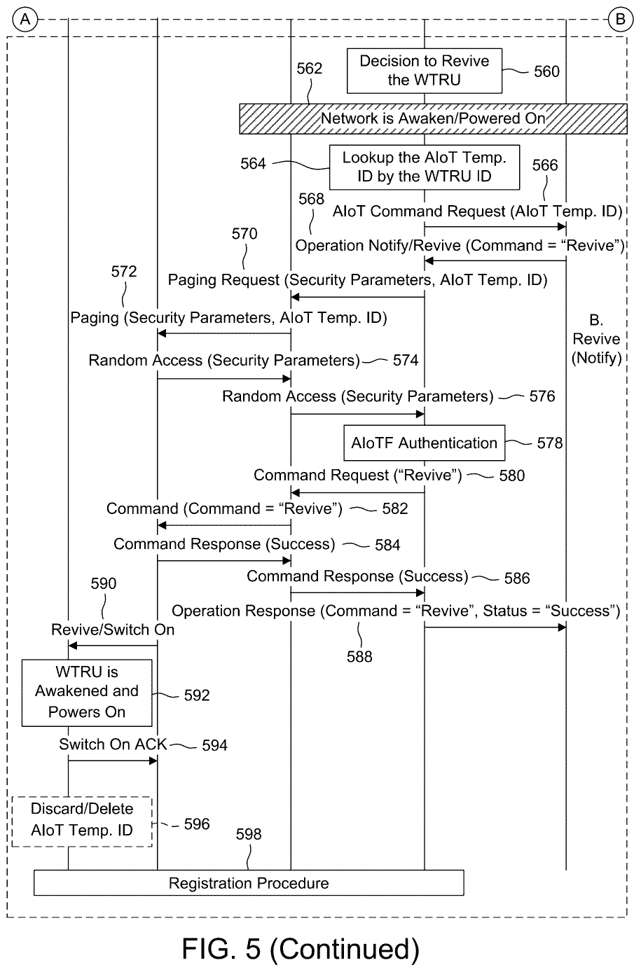

FIG. 5 illustrates a message flow diagram 500 of a power-saving procedure for a system. As shown in FIG. 5, the system includes an AIoT-assisted WTRU 502, a RAN/Reader 504, a core network (CN) 506, and an AIoT AF 508. The AIoT-assisted WTRU 502 of the system may include a WTRU 510 and an AIoT device 512. The WTRU 510 may be in functional proximity to the AIoT device 512. For example, the WTRU 510 and the AIoT device 512 may be coupled together via an interface. The interface may be a wireless or wireline link or connection.

The core network 506 of the system may include network functions (NFs) and physical functions (PFs). For example, an Access and Mobility Management Function (AMF) may manage the context of the WTRU 510 while an AIoT Function (AIoTF) may have the context of the AIoT device 512. The AMF may determine the interactions with the AIoTF service as needed to perform a revive/wakeup procedure for the WTRU 510. The AIoT Application Function (AIoT AF) may also manage the AIoT session and maintain the association between a device identifier (e.g., a WTRU ID) of the WTRU 510 and a temporary identifier (e.g., an AIoT temp. ID) as further described below.

As shown in FIG. 5, the message flow diagram 500 of the power-saving procedure may enable the AIoT-assisted WTRU 502 to be powered off/down and/or enter a dormant or power saving state. The AIoT-assisted WTRU 502 may be subsequently revived or awakened by the core network 506 via the AIoT device 512. For example, the AIoT-assisted WTRU 502 may subscribe to a revive event or a power-on procedure of the core network 506. After powering off/down and/or entering a dormant state, the AIoT device 512 of the AIoT-assisted WTRU 502 may receive a command from the core network 506 to wake up the WTRU 510 from the dormant state and to enter into a power on or active state.

At block 514, the WTRU 510 may be awakened or powered on and the core network 506 may be awakened or powered on at block 516. A block 520, the WTRU 510 may perform and complete a registration procedure. As part of the registration procedure, the WTRU 510 and the core network 506 may exchange capabilities related to the support of the power savings procedure implemented by the system. For example, both the WTRU 510 and the core network 506 may support the power-saving procedure.

At block 522, the core network 506 may decide to retire the WTRU 510 or put the WTRU in a dormant state (e.g., turn off the power of the WTRU 510). In some implementations, the WTRU 510 may decide itself to power-off/down and/or enter into a dormant mode.

At 524, the core network 506 may send a dormancy directive message to the WTRU 510. For example, a dormancy directive message may be sent by the core network 506 to the AIoT-assisted WTRU 502. The dormancy directive message may include information about a triggering procedure to awaken or power-on the WTRU 510. For example, the core network 506 may send a command to the WTRU 510 to trigger the WTRU 510 to wake-up and/or enter into a power-on mode. The message may be issued over the NAS layer or in any other integrity/replay-protected way. In some implementations, the core network 506 may send a dormancy permission message to the WTRU 510 of the AIoT-assisted WTRU 502 at 526. The dormancy permission message may include information about a command from the core network 506 to trigger the WTRU 510 to awaken and/or enter into a power-on state. The dormancy permission message may be issued over the NAS layer or in any other integrity/replay-protected way.

At block 528, the WTRU 510 may decide to power off/down or retire (e.g., turn the power off to save energy). In some implementations, the core network 506 or another device may instruct the WTRU 510 to power off/down or enter into a power-off mode. At block 530, the WTRU 510 of the AIoT-assisted WTRU 502 may derive a temporary identifier (e.g., AIoT temp ID). The WTRU 510 may provide the temporary identifier to the AIoT device 512. In some implementations, the temporary identifier may be derived by the core network 506 and provided to the WTRU 510 and/or the AIoT device 512. For example, the WTRU 510 or the AIoT device 512 may send a request or message to the core network 506 for a temporary identifier. In response, the core network 506 may derive a unique temporary identifier (e.g., AIoT temp ID) and associate the temporary identifier with a device identifier of the WTRU 510. The core network 506 may send a message to the WTRU 510 and/or AIoT device 512 including the temporary identifier (e.g., AIoT temporary ID).

At 532, the WTRU 510 may send or deliver the temporary identifier to the AIoT device 512. At block 534, the AIoT device 512 may associate the temporary identifier with the WTRU 510. In some implementations, the AIoT device 512 may associate the temporary identifier with a device identifier of the WTRU 510. At 536, the AIoT device 512 may send a message to the WTRU 510 acknowledging receipt of the temporary identifier.

At 538, the WTRU 510 may issue to the core network 506 a request to subscribe to a revive event or a power-on procedure. For example, the WTRU 510 may send a message to the core network 506 requesting to subscribe to a revive event (e.g. a power-on procedure). The message may include the temporary identifier (e.g., the AIoT temp. ID) and the device identifier associated with the WTRU 510 (e.g., WTRU ID). The message may be transmitted over an integrity and replay-protected media (e.g., NAS). The message may also be considered by the core network 506 as an indication that the WTRU 510 may desire or plan on entering into a powered-off or dormant state. When the WTRU 510 is in a dormant state, the core network 506 may mark or indicate the WTRU 510 as “unreachable” in the core network 506.

At block 540, the core network 506 may check for the uniqueness of the received temporary identifier (e.g., AIoT temp. ID) . When the temporary identifier is not unique, the core network 506 may either request a new temporary identifier from the WTRU 510 or derive a unique temporary identifier itself. At block 542, the core network 506 may associate the received temporary identifier (e.g., AIoT temp. ID) or the new temporary identifier with the device identifier of the WTRU 510 (e.g., WTRU ID). In some implementations, the core network 506 may verify that the temporary identifier provided by the WTRU 510 has been previously generated by the core network 506 and associated with the device identifier (e.g., WTRU ID) of the WTRU 510.

At 544, the core network 506 may issue a message to the WTRU 510 acknowledging acceptance of the subscription request for a revival event or power-on procedure. However, if the temporary identifier (e.g., AIoT temp. ID) provided by the WTRU 510 and previously generated by the core network 506 do not match, the core network 506 may reject the request by the WTRU 510 for a subscription to a revival event (e.g., a power on procedure).

At 546, the WTRU 510 may provide a notification to the AIoT device 512 of the WTRU's readiness to power off. For example, the WTRU 510 may provide a message to the AIoT device 512 that the WTRU 510 will be powering off/down and/or entering a dormant state. In some implementations, the WTRU 510 may provide one or more slots to the AIoT device 512 when the WTRU 510 may be ready to receive a message from the AIoT device about waking up and/or powering on.

At block 548, the WTRU 510 may power off or down. At 550, the core network 506 may be powered off or may enter an inactive or dormant state. At block 552, the WTRU 510 may be in a powered-off state and/or may be in a dormant state. In some embodiments, the core network 506 may not be powered off and may remain in a powered-on or active state while the WTRU is powered off.

After the WTRU 510 is powered off, the core network 506 may implement a procedure to revive or awaken a WTRU, such as WTRU 510. For example, the core network 506 may decide to revive or awaken the WTRU 510 that is associated with a certain device identifier (e.g., WTRU ID) at block 550. The decision to revive the WTRU 510 may be triggered by incoming data for the WTRU 510. For example, the core network 506 may be triggered to revive or power on the WTRU 510 based on one or more of the following: (1) a need to transmit a control plane (e.g. NAS) message to the WTRU 510; (2) the length of the power-off period (e.g., the WTRU 510 might be allowed to turn off for a certain period); (3) the network desires to keep track of the WTRU 510 and does not want to lose track in case the WTRU 510 has moved or changed location; (4) received an update from a certain AF regarding the on/off state of the WTRU 510 (e.g., the AF may request that the WTRU 510 not be powered off in the current location); and/or (5) a policy-based decision based on any of the above factors and/or any of environmental parameters (e.g., day of the year, time of day, weather conditions, type of the WTRU 510).

At block 562, the core network 506 may be awakened or powered-on and may decide to awaken or power on the WTRU 510. At block 564, the core network 506 may look up a temporary identifier (e.g., AIoT temp. ID) associated with a device identifier (e.g., WTRU ID) of the WTRU 510.

At 566, the core network 506 may send a command request message to the AIoT AF 508. The message may contain a type of command (e.g., “Revive”) and a temporary identifier (e.g., AIoT temp. ID). At 568, the AIoT AF 508 may issue a notify/revive request to the core network 506 including a command (e.g., a revive request) and the temporary identifier (e.g., an AIoT temp. ID) associated with the WTRU 510. In some implementations, the AIoT AF 508 may not be involved and the core network 507 may send the revive command to the WTRU 510 and/or AIoT device 512 without the redirection to the AIoT AF 508.

At 570, the core network 506 may send a paging request to the RAN/Reader 504 with security parameters and the temporary identifier (e.g., an AIoT temp. ID) associated with the WTRU 510. At 572, the RAN/Reader 504 may page the AIoT device 512 with a message containing the temporary identified and the security parameters. The AIoT device 512 may respond to the RAN/Reader 504 with a random access message which includes security parameters at 574.

At 576, the RAN/Reader 504 may relay the random access message with the security parameters to the core network 506. At block 578, the core network 506 may authenticate the AIoT device 512. After the authentication is successfully performed, the core network 506 may issue a command request message (e.g., a request to revive) to the RAN/Reader 504 at block 580.

At 582, the RAN/Reader 504 may send the command request message (e.g., a request to revive) to the AIoT device 512. At 584, the AIoT device 512 may process the command request message and if successfully processed, the AIoT device 512 may notify the RAN/Reader 504 that the command request message was successfully processed. At 586, the RAN/Reader 504 may relay to the core network 506 that the command response message was successfully processed. At 588, the core network 506 may notify the AIoT AF 508 about the successful processing of the command request message.

At 590, the AIoT device 512 may send a revive/switch-on command to the WTRU 510. At block 592, the WTRU 510 may be awakened and may power on. At 596, the AIoT device 512 may receive from the WTRU 510 an acknowledgement that the WTRU 510 has been powered on.

At 596, the WTRU 510 may discard/delete the temporary identifier (e.g., AIoT temp ID) derived by the WTRU 510 or the core network 506. At 598, the WTRU 510 may perform and complete a registration procedure.

In some implementations, a single subscribe to a revive event or power on command/procedure may allow the WTRU 510 to transition multiple times from a power-off state to power on state. As such, the WTRU 510 and core network 506 may execute steps 522 to 544 of the message flow diagram 500 of FIG. 5. These steps may allow the WTRU 510 to subscribe and to be notified about a network decision or operation to revive or awaken the WTRU 510. Once subscribed, the WTRU 510 may inform the network multiple times that it wishes to power down. In the first option, when the WTRU 510 may determine that it wants to power down, it may send a “power-down” signaling message to the RAN/Reader 504 (e.g., RRC message), which notifies the core network 596 that the WTRU 510 is powering down. Upon reception of an indication that the core network 506 has received the “power-down” signaling message, the WTRU 510 may power off. The core network 506 may then provide a notification to awaken the WTRU 510. In a second option, when the WTRU 510 determines that it wants to power down, it may send a “power-down” signaling message to the core network 506 (e.g., NAS message), which notifies the core network 506 that the WTRU 510 is powering down. Upon reception of an indication that the network has received the “power-down” signaling message, the WTRU 510 may power off. The network may then provide a notification or message to awaken or revive the WTRU 510. In both options, after the WTRU 510 powers on, the request to subscribe to a revive event or operation may still be active. To terminate the request to subscribe, the WTRU 510 may execute a new NAS signaling exchange with the core network 506 (e.g. NAS Unsubscribe). To modify the request to subscribe, the WTRU 510 may execute a new NAS signaling exchange with the core network 506 (e.g. NAS Modify).

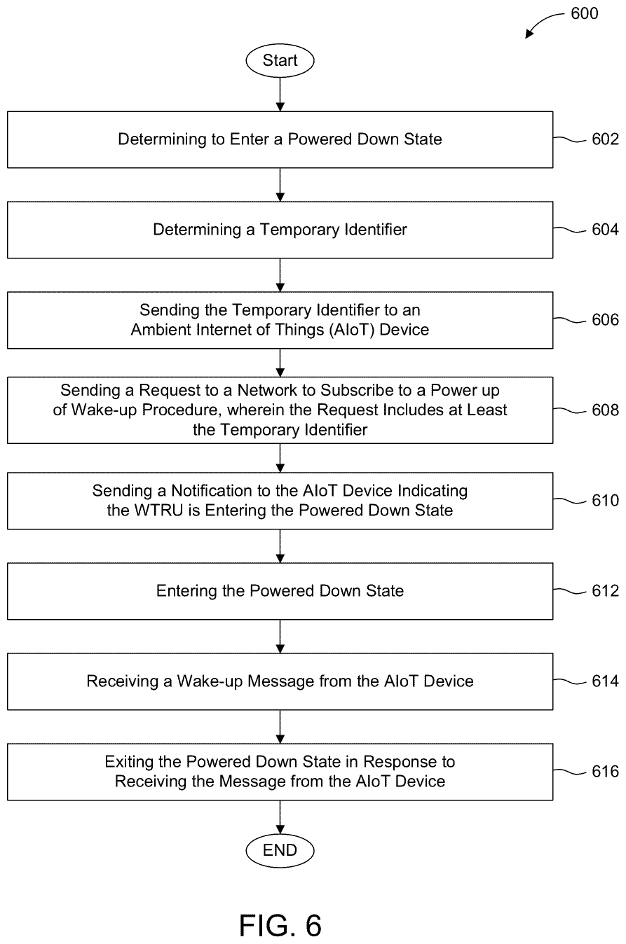

Referring now to FIG. 6, a flow diagram of a method 600 for power savings is shown, according to an exemplary implementation. The method 600 may be implemented by an AIoT-assisted WTRU or a WTRU. The AIoT-assisted WTRU may include a WTRU and an AIoT device. The WTRU may be in communication with the AIoT device. The WTRU 510 and the AIoT device 512 may be linked via an interface. The interface may be a wireless or wireline link or connection In some implementations, the WTRU and the AIoT device may be physically paired (i.e. physically connected). For example, a smartphone casing may contain a WTRU and an AIoT Device. Such a device may be called an AIoT-assisted WTRU.

The method 600 may enable an AIoT-assisted WTRU to be powered off/down or to enter into a dormant or power-saving state. The AIoT-assisted WTRU may be subsequently revived or awakened by the core network 506 via the AIoT device. For example, the AIoT-assisted WTRU may subscribe to a revive event or a power-on procedure of the core network. After powering off/or down or entering a dormant state, the AIoT device of the AIoT-assisted WTRU may receive a command from the core network to wake-up the WTRU from a dormant state and to power on. Thus, the AIoT device may assist the WTRU in revival (powering on) and the AIoT device may be triggered by the network. For example, the AIoT device can be activated by a command from the network to revive the WTRU from its dormant or power-saving state.

At block 602, the method may involve determining to enter a powered-down state. For example, the WTRU may receive a non-access stratum (NAS) message from the network. The message may request that the WTRU enter a powered off/down or dormant state.

At block 604, the method may involve determining a temporary identifier; For example, the WTRU may derive a temporary identifier. Allowing the WTRU to generate the temporary identifier may present the advantage of using less restricted WTRU capabilities for the temporary identifier generation. In some implementations, the network (e.g., core network) may generate the temporary identifier and may send it to the WTRU and/or the AIoT device. The temporary identifier may be received by the WTRU from the network in a NAS message that requests that the WTRU enter a powered off/down or dormant state. Allowing the network to provide the temporary identifier to the WTRU has an advantage in that the network may know of other temporary identifiers that are assigned in the network and the network can therefore help to guarantee the uniqueness of the temporary identifier.

At block 606, the method may involve sending the temporary identifier to an Ambient Internet of Things (AIoT) device. For example, the WTRU may send the temporary identifier to an AIoT device. The AIoT Device may be a device that is connected to the WTRU. The connection between the AIoT Device and the WTRU may be via a wireless interface such as WiFi or Bluetooth. In some implementations, the connection between the AIoT Device and the WTRU may be via a physical (i.e. not wireless) connection. The WTRU may use an API (e.g. an AT command) to send the temporary identifier to the AIoT device.

At block 608, the method may involve sending a request to a network to subscribe to a power-on or wake-up procedure, wherein the request includes at least the temporary identifier. For example, the WTRU may send a NAS message to the network. The message may include information that can be used by the network to trigger the WTRU to be awakened from the powered off/down state. For example, the information may include a temporary identifier.

At block 610, the method may involve sending a notification to the AIoT device indicating the WTRU is entering the powered-down state. For example, the WTRU may send a notification to the AIoT device. The notification may indicate to the AIoT device that the WTRU is entering a powered off/down state, and the notification may trigger the AIoT device to listen for a message from the network that includes the temporary identifier. The AIoT Device may use an API (e.g. an AT command) to send the notification to the AIoT device.

At block 612, the method may involve entering the powered-down state. At block 614, the method may involve receiving a wake-up message from the AIoT device. For example, the WTRU may receive a notification from the AIoT device. The notification may indicate to the WTRU that the WTRU should exit the powered-off/down or dormant state and enter into a power-on state. The AIoT Device may use an API (e.g. an AT command) to receive the notification from the WTRU. At block 616, the method may involve exiting the powered-down state in response to receiving the wake-up message from the AIoT device In some implementations, the message from the AIoT device triggers the WTRU to initiate the NAS procedure with the network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

### ABBREVIATIONS AND ACRONYMS

3GPP 3rd Generation Partnership Project 3GPP
AIoT Ambient Iot
AIoTF AIoT Function
AF Application Function
AMF Access Management Function
CN Core Network
DRX Discontinuous Reception
CDRX Connected mode DRX
IoT Internet of Things
NAS Non-Access Stratum
NF Network Function
NR New Radio
PF Physical Function
RAN Radio Access Network
UE User Equipment

What is claimed:

1. A method implemented by a wireless transmit/receive unit (WTRU), the method comprising:
determining to enter a powered down state;
determining a temporary identifier;
sending the temporary identifier to an ambient internet of things (AIoT) device;
sending a request to a network to subscribe to a power on or wake-up procedure, wherein the request includes at least the temporary identifier;
sending a notification to the AIoT device indicating the WTRU is entering the powered down state;
entering the powered down state;
receiving a wake-up message from the AIoT device; and
exiting the powered down state in response to receiving the wake-up message from the AIoT device.

2. The method of claim 1, wherein the WTRU is physically coupled to the AIoT device, and wherein the network is a core network.

3. The method of claim 1, further comprising receiving, from the network, a message requesting the WTRU to enter the powered down state.

4. The method of claim 3, wherein the message includes a non-access stratum (NAS) dormancy directive indicating a triggering procedure of the network.

5. The method of claim 1, further comprising receiving a non-access stratum (NAS) dormancy permission enabling a triggering procedure for the WTRU.

6. The method of claim 1, wherein the temporary identifier is determined by at least one of the WTRU or the AIoT device, and wherein the determination to enter the powered down state is determined by the WTRU.

7. The method of claim 1, further comprising receiving the temporary identifier from the network.

8. The method of claim 1, wherein the request sent to the network includes the temporary identifier and a device identifier, and wherein the notification sent to the AIoT device indicates to the AIoT device to listen for a message from the network that includes the temporary identifier.

9. The method of claim 1, further comprising:
determining a uniqueness of the temporary identifier;
determining a second temporary identifier based on the uniqueness determination; and
sending the second temporary identifier to the AIoT device.

10. The method of claim 1, further comprising initiating a non-access stratum (NAS) procedure.

11. A wireless transmit/receive unit (WTRU) comprising:
a transceiver;
a processor configured to:
determine whether to place the WTRU in a powered down state;
determine a temporary identifier;
send the temporary identifier to an ambient internet of things (AIoT) device;
send a request to a network to subscribe to a power on or wake-up procedure, wherein the request includes at least the temporary identifier;
send a notification to the AIoT device indicating the WTRU is entering the powered down state;
cause the WTRU to enter the powered down state;
receive a wake-up message from the AIoT device; and
exit the powered down state in response to receiving the wake-up message from the AIoT device.

12. The WTRU of claim 11, wherein the processor is further configured to receive, from the network, a message requesting the WTRU to enter the powered down state, wherein the WTRU is physically coupled to the AIoT device, and wherein the network is a core network.

13. The WTRU of claim 12, wherein the message includes a non-access stratum (NAS) dormancy directive indicating a triggering procedure of the network.

14. The WTRU of claim 11, wherein the processor is further configured to receive a non-access stratum (NAS) dormancy permission enabling a triggering procedure for the WTRU.

15. The WTRU of claim 11, wherein the request sent to the network includes the temporary identifier and a device identifier.

16. The WTRU of claim 11, wherein the processor is further configured to initiate a non-access stratum (NAS) procedure.

17. A method implemented by a network, the method comprising:
determining to place a wireless transmit/receive unit (WTRU) in a powered down state;
receiving a request from the WTRU to subscribe to a power on or wake-up procedure, wherein the request includes at least a temporary identifier;
sending an acknowledgment to the WTRU indicating the WTRU is subscribed;
determining to initiate the power on or wake-up procedure;
retrieve the temporary identifier associated with the WTRU; and
send a message to an ambient internet of things (AIoT) or a radio access network (RAN) indicating the WTRU is to exit the powered down state.

18. The method of claim 17, further comprising sending, to the WTRU, a message requesting the WTRU to enter the powered down state.

19. The method of claim 18, wherein the message includes a non-access stratum (NAS) dormancy directive indicating a triggering procedure of the network.

20. The method of claim 17, further comprising sending, to the WTRU, a non-access stratum (NAS) dormancy permission enabling a triggering procedure for the WTRU.
